(19) United States
(12) Patent Application Publication
(10) Pub. No.: US 2025/0131431 A1
(43) Pub. Date: Apr. 24, 2025

(54) ADVANCED MULTI-SOURCE TRANSACTION AUTHORIZATION SYSTEM FOR ENHANCED FINANCIAL TRANSACTIONS

(71) Applicant: Paayj Payments, Inc., Las Vegas, NV (US)

(72) Inventors: Sahil Janmejay Patel, Las Vegas, NV (US); Daniel Carlos Pereira, Las Vegas, NV (US)

(21) Appl. No.: 18/601,361

(22) Filed: Mar. 11, 2024

Related U.S. Application Data
(60) Provisional application No. 63/545,006, filed on Oct. 20, 2023.
(60) Provisional application No. 63/545,541, filed on Oct. 24, 2023.
(60) Provisional application No. 63/619,524, filed on Jan. 10, 2024.

(51) Int. Cl. G06Q 20/40

(52) U.S. Cl. CPC G06Q 20/4012; G06Q 20/40145

(57) ABSTRACT

A system user computer, a payment system and a method are provided for facilitating split fee payments within existing financial institution infrastructure. The system user computer includes a processor, a memory database connected to the processor, and a computer readable medium coupled to the processor, the computer readable medium including code executable by the processor, to cause the processor to implement a method including steps of (a) creating an account for split fee payments for a financial transaction from multiple funding sources using payment processing infrastructure of a merchant and (b) specifying authorization evaluations required to approve the financial transaction.

### RELATED APPLICATIONS

This application claims priority to U.S. Provisional Patent Application Ser. No. 63/545,006, filed Oct. 20, 2023, U.S. Provisional Patent Application Ser. No. 63/545,541, filed Oct. 24, 2023, and U.S. Provisional Patent Application Ser. No. 63/619,524, filed Jan. 10, 2024, the entirety of which are incorporated by reference herein.

### FIELD OF THE INVENTION

This document relates generally to a system user computer, a split fee payment system and a method of facilitating split fee payments using financial institution infrastructure.

### BACKGROUND OF INVENTION

The landscape of financial transactions has undergone a rapid transformation over recent decades. Traditionally, financial transactions were cash-based. This paradigm shifted with the advent of digital technology, giving rise to more complex and varied transaction methods including checks, credit cards, and later, online payment systems.

The introduction of magnetic stripe payment cards represented a significant milestone, offering consumers a convenient and secure alternative to cash. However, as digital transactions grew in complexity and volume, driven by globalization and the burgeoning e-commerce sector, they also became more susceptible to security vulnerabilities. This necessitated innovations in payment security, leading to the development of EMV (Europay®, MasterCard®, and Visa®) chip technology. EMV chips significantly enhanced the security of card-present transactions by introducing dynamic authentication, a stark contrast to the static nature of magnetic stripes.

This disclosure introduces a software layer designed to seamlessly integrate anywhere within existing EMV infrastructure to align a transaction authorization request with a user's needs from a transaction. The layer acts as an addition to EMV infrastructure offering comprehensive authorization capabilities to facilitate transactions involving multiple accounts, real-time two-factor authorization via a secondary device, and a variety of other notable use cases, without altering the flow of information and without requiring additional steps from the traditional components of EMV infrastructure. The system is available via an application or interface while also being adaptable for integration with third-party platforms. The system emphasizes user and transaction data security and supports a multitude of payment methods from EMV payment cards to digital wallets. It also enables multi-payment method transactions through innovative tokenization. This disclosure revolutionizes financial transactions and EMV infrastructure.

### SUMMARY

In accordance with the purposes and benefits set forth herein, a new and improved system user computer, comprises, consists of or consists essentially of: (a) a processor, (b) a memory database connected to the processor, and (c) a computer readable medium coupled to the processor, the computer readable medium comprising code executable by the processor, to cause the processor to implement a method. That method comprises, consists of or consists essentially of the steps of: (1) creating an account for split fee payments for a financial transaction from multiple funding sources using payment processing infrastructure of a merchant and (2) specifying authorization evaluations required to approve the financial transaction.

The authorization evaluations may be selected from a group consisting of an event, an allocation, a criteria or combinations thereof. The event may be a personal identification number (PIN), a biometric verification, multi-factor authentication, two factor authorization from a secondary communication device within a specified time frame, an approval generated by artificial intelligence, another action to confirm the financial transaction is legitimate or combinations thereof. The allocation may be a percentage or dollar amount of the financial transaction to be apportioned to (a) each participant of the account, (b) each of the multiple funding sources or (c) each participant of the account and each of the multiple funding sources. The criteria may be a limitation on transaction conditions.

In at least some embodiments of the system user computer, the method further comprises the step of adding at least one of the following to the account: (a) a new participant, (b) a new funding source and (c) a new authorization evaluation. In at least one embodiment of the system user computer, the method further includes the step of linking authorization evaluations to (a) a participant account, (b) a particular funding source or (c) a participant account and a particular funding source. In at least one possible embodiment, the method includes transmitting account information to a server computer for a split fee payment system. In any of the possible embodiments, the user computer may comprise a communication device having internet access, including mobile devices such as a cell phone.

In accordance with an additional aspect, a new and improved split fee payment system is provided. That split fee payment system comprises, consists of or consists essentially of: (a) a server computer (including one or more server computers), (b) a memory database connected to the server computer, (c) a computer readable medium coupled to the server computer, the computer readable medium comprising code executable by the server computer, to cause the server computer to implement a method.

That method comprises, consists of or consists essentially of the steps of: (1) receiving account information from a system user computer including participant data, multiple funding source data and authorization evaluation data, (2) storing the account information, including the participant data, the multiple funding source data and the authorization evaluation data, in the memory database, (3) receiving (i) information for a financial transaction from financial institution infrastructure including a point of sale device, a merchant bank, a credit card network and a credit card issuer and (ii) any transmitted authorization evaluation data from the system user computer of the participant, (4) analyzing the information and the transmitted authorization evaluation data against the account information to determine (a) participants involved in the financial transaction, (b) if sufficient funds are available at the funding sources of the participants involved in the financial transaction and (c) if the transmitted authorization evaluation data matches the stored authorization evaluation data to approve the financial transaction, and (5) sending an approval or rejection of the financial transaction to the point of sale device.

In one or more of the many possible embodiments of the split fee payment system, the method further includes the steps of receiving funds from the funding sources for the financial transaction in a split fee payment system settlement account and sending the funds from the split fee payment system settlement account to the merchant's bank.

The authorization evaluation data may be selected from a group consisting of an event, an allocation, a criteria or combinations thereof. The event may be a personal identification number (PIN), a biometric verification, multi-factor authentication, two factor authorization from a secondary communication device within a specified time frame, an approval generated by artificial intelligence, another action to confirm the financial transaction is legitimate or combinations thereof. The allocation may be a percentage or dollar amount of the financial transaction to be apportioned to (a) each participant of the account, (b) each of the multiple funding sources or (c) each participant of the account and each of the multiple funding sources. The criteria may be a limitation on transaction conditions as described in greater detail below.

The method may further include the step of sending to, receiving from and requesting payment data from any component of a financial institution infrastructure including point of sale devices, merchant banks, credit card networks and credit card issuers.

The system user computer may comprise a communication device having internet access, such as a cell phone.

In accordance with still another aspect, a new and improved method is provided for facilitating split fee payments. That method comprises, consists of or consists essentially of the steps of: (1) receiving account information, from a system user computer, including participant data, multiple funding source data and authorization evaluation data, (2) storing the account information, including the participant data, the multiple funding source data and the authorization evaluation data, in the memory database, (3) receiving (i) information for a financial transaction from financial institution infrastructure including a point of sale device, a merchant bank, a credit card network and a credit card issuer and (ii) any transmitted authorization evaluation data from the system user computer of the participant, (4) analyzing the information and the transmitted authorization evaluation data against the account information to determine (a) participants involved in the financial transaction, (b) if sufficient funds are available at the funding sources of the participants involved in the financial transaction and (c) if the transmitted authorization evaluation data matches the stored authorization evaluation data to approve the financial transaction, and (5) sending an approval or rejection of the financial transaction to the point of sale device.

The method may further include the steps of receiving funds from the funding sources for the financial transaction in a split fee payment system settlement account and sending the funds from the split fee payment system settlement account to the merchant's bank. The method may further include the step of selecting authorization evaluation data from a group consisting of an event, an allocation, a criteria or combinations thereof.

As previously noted, the event may be a personal identification number (PIN), a biometric verification, multi-factor authentication, two factor authorization from a secondary communication device within a specified time frame, an approval generated by artificial intelligence, another action to confirm the financial transaction is legitimate or combinations thereof. The allocation may be selected from a group consisting of a percentage or dollar amount of the financial transaction to be apportioned to (a) each participant of the account, (b) each of the multiple funding sources or (c) each participant of the account and each of the multiple funding sources. The criteria may be a limitation on transaction conditions.

The method may further include the steps of sending to, receiving from and requesting payment data from any component of a financial institution infrastructure including point of sale devices, merchant banks, credit card networks and credit card issuers.

In accordance with yet another aspect, a method of facilitating split fee payments comprises, consists of or consists essentially of the steps of: integrating into a financial institution infrastructure, including a point of sale device, a merchant bank, a credit card network and a credit card issuer, a server computer and a memory database including a computer readable medium coupled to the server computer, the computer readable medium comprising code executable by the server computer, to cause the server computer to be adapted for: (1) receiving, interpreting, utilizing, manipulating and sending, by the server computer, data via financial institution infrastructure request and response cryptograms, (2) receiving, by the server computer, authorization evaluation data from mobile communication devices of users outside of the financial institution infrastructure, (3) analyzing, by the server computer, financial transaction information received from the financial institution infrastructure and transmitted authorization evaluation data received from mobile communication devices of users to determine (a) participants involved in a financial transaction, (b) if sufficient funds are available at funding sources of participants involved in the financial transaction and (c) if the transmitted authorization evaluation data matches stored authorization evaluation data to approve the financial transaction, and (4) sending, by the server computer, an approval or rejection of the financial transaction to the point of sale device.

Still further, the method may include the step of issuing, by the server computer, tokens representing a user, a group of users, a funding source, a group of funding sources, an authorization evaluation, a group of authorization evaluations and combinations thereof. The method may include the steps of receiving, by the server computer, funds from any funding sources for the financial transaction in a split fee payment system settlement account and sending, by the server computer, the funds from the split fee payment system settlement account to the merchant's bank.

The method may include issuing, by the server computer, a payment method. The method may include linking, by the server computer, the payment method to (a) a user account, (b) a token or (c) a user account and a token.

In the following description, there are shown and described several embodiments of the system user computer, split fee payment system and related methods for facilitating split fee payments. As it should be realized, the system user computer, split fee payment system and method are capable of other, different embodiments and their several details are capable of modification in various, obvious aspects all without departing from the device and method as set forth and described in the following claims. Accordingly, the drawing and descriptions should be regarded as illustrative in nature and not as restrictive.

### BRIEF DESCRIPTION OF THE DRAWING FIGURES

The accompanying drawing figures incorporated herein by reference and forming a part of the specification, illustrate several aspects of the new and improved system user computer, split fee payment system and method.

FIG. 1 shows an illustrative example of account creation, including compliance with financial technology standards, KYC, BSA AML, PCI DSS, in detail.

FIG. 2 shows an illustrative example of multi-user group creation at a high level.

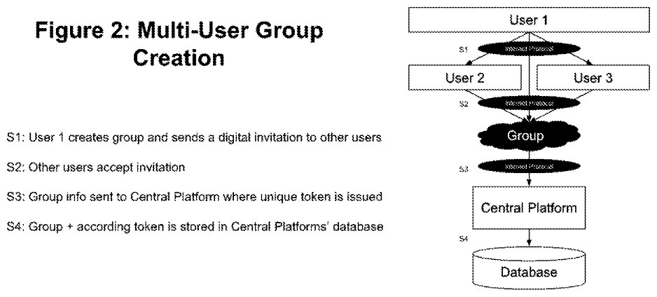

FIG. 3 shows an illustrative example of single-user group creation at a high level.

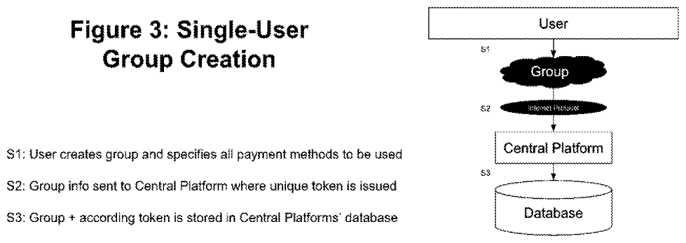

FIG. 4 shows an illustrative example of the processing method in which the proposed system integrated into EMV infrastructure directly following the card network would operate in detail, including data security considerations.

FIG. 5 shows an illustrative example of a high level overview of current EMV infrastructure without the proposed system's integration.

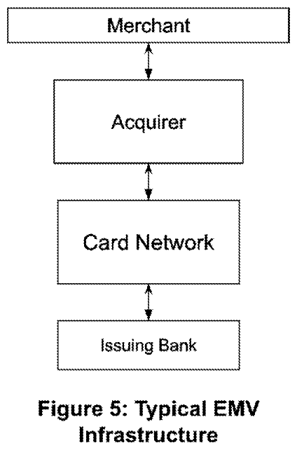

FIG. 6 shows an illustrative example of a high level overview of the processing method in which the proposed system integrated into EMV infrastructure directly following the card network.

FIG. 7 shows an illustrative example of a high level overview of the processing method in which the proposed system is integrated with merchant's acquirer.

FIG. 8 shows an illustrative example of the flow of events a user experiences when a presentation method is issued for each group created.

FIG. 9 shows an illustrative example of the flow of events a user experiences when a presentation method is issued during account creation.

FIG. 10 shows an illustrative example of the flow of events in the case the system determines that the authorization evaluations were successfully assessed.

FIG. 11 shows an illustrative example of the flow of events in the case the system determines that the authorization evaluations were unsuccessfully assessed.

FIG. 12 is a schematic illustration of a system user computer.

FIG. 13 is a schematic illustration of a split fee payment system.

Reference will now be made in detail to the present preferred embodiments of the device.

### DETAILED DESCRIPTION

The proposed invention introduces a software system designed to integrate seamlessly with transaction authorization. This layer is specifically designed to receive payment data, conduct authorization checks using a variety of data from a variety of sources, validate specific transaction conditions (user-defined, live inputs, or otherwise), and issue an approval or rejection that approves or rejects the transaction. Hence forth, approval or rejection messages, to accept or decline transactions, are referred to as “authorizations”. It should be understood by those skilled in the field of financial technology (FinTech) that the invention is not confined to the outlined embodiments. The invention can be implemented without adhering to all the specific details mentioned.

Traditionally, authorizations are a signal from the issuer bank (the issuer of the buyer's payment card) that the buyer has sufficient funds in their account to transact or not. These messages are sent to the merchant's POS system or online payment portal, henceforth referred to as “POS device”, and are how a merchant confirms a buyer is able to complete payment in exchange for goods or services rendered.

This system issues comprehensive authorizations that could confirm the amount of funds available in one account in addition to other conditions, before issuing an authorization. It is important to note that “comprehensive” is referring to the calculation of the authorization, the content of an authorization message does not change. This system's authorizations are more comprehensive than traditional authorizations because there is additional evaluation involved to determine if a transaction can be authorized. One innovative aspect of this system is that nothing changes for any of the parties or components involved in the authorization flow. This system fits into the authorization flow infrastructure as a filter that approves or rejects transactions.

This system can be built within financial institution infrastructure/EMV infrastructure. EMV infrastructure includes POS devices, the acquiring bank of the merchant, “acquirers”, the card networks, such as Europay®, Mastercard®, Discover®, American Express® (AMEX®), and Visa®, and the issuing bank of the user's payment card, “issuers”. This layer can be accessed via EMV payment card.

The system can exist as an independent layer between the existing components of EMV infrastructure, for example between card networks and issuer banks. In this case, the system is accessed when users transact with EMV payment cards issued by the system.

Alternatively, this system can be integrated into an existing component of EMV infrastructure. Henceforth, a component of EMV infrastructure with which the system is integrated is referred to as a “system equipped third party.” In this case, the system is accessed at the same time when the system equipped third party is sending or receiving data.

EMV infrastructure acts as a network facilitating the transfer of encrypted data, such as transaction cryptograms, and unencrypted data, such as transaction details, from the POS device to the issuer for authorization.

A transaction cryptogram is an encrypted alphanumeric code generated during an EMV card transaction. Cryptograms typically contain the buyer's card's risk parameters, transaction counter, the card's primary account number (PAN), and other card specific information. This cryptogram, or code, is crucial for securing cardholder data and validating transactions. Any sensitive data transmitted via cryptograms is stored as tokens. Tokens are strings of alphanumeric characters that serve as identifiers for data points used in secure data transmission. If a cryptogram is accessed by a malactor, the tokens within are useless without a token key. Those with token keys are able to align a token with the data to which it points. In the context of EMV transactions, there are different types of cryptograms used for various purposes.

When a user transacts with an EMV payment card, an Authorization Request Cryptogram (ARQC) is generated by the card and sent through EMV infrastructure, from the POS device to the issuer bank. The issuer uses a key, known only to them and the payment network, to decrypt the ARQC and a token key to decrypt the tokens within the ARQC. The issuer uses the data within the ARQC to associate the payment card's PAN with an account holder and account to determine if the buyer has sufficient funds. The issuer also assesses the other data sent in the authorization request transmission, such as merchant details, timestamp, etc., to validate the authenticity of the transaction. If the issuer determines a transaction to be valid, they could issue an Authorization Response Cryptogram (ARPC) indicating an accepted transaction. If the issuer determines a transaction to be invalid, they could issue an Application Authentication Cryptogram (AAC) indicating a rejected transaction.

ARPCs and AACs, “response cryptograms”, contain the authorization code, indicating approval or rejection, as well as issuer authentication data to ensure that the issuer's response has not been tampered with. The POS device and issuer use a shared set of cryptographic keys and algorithms to ensure the POS device can decrypt and understand the response cryptogram's content. Transaction Certificates (TCs), typically issued by the card itself, indicate a successful transaction. The TC is sent to the card network and then the issuer for final approval and record-keeping. This certificate includes data such as the transaction amount, date, and time, as well as a cryptographic seal ensuring the transaction's authenticity and integrity. The TC serves as proof that the transaction was completed as intended, providing security against fraud and ensuring accurate transaction records for both the cardholder and the issuer. Unsuccessful transactions are also sent to the card network and issuer for record keeping; however they do not need the same level of granularity since no funds were transferred.

These cryptograms play a crucial role in the transaction process, as they authenticate the card and the transaction, prevent card replication, and secure sensitive data during transmission.

The users of this system are generally one or multiple transacting users. These users could be directly interacting with the system via a mobile or web interface or application, or via a third party leveraging the system's application programming interface (API) benefits. It is important to note that these third parties are different from system equipped third parties and will be referred to solely as “third parties”. System equipped third parties are integral for the system's operation. Third parties are entities who wish to leverage the benefits of the system for managing a payment card program, broadening the capabilities of their payment card program, or simply to provide their users with the benefits of comprehensive authorizations. API is only one example of the systems integration into third parties. The system is also designed to be a licensable software service that can be established directly on a third parties' server system. Henceforth, users of the system, whether they are interacting with the system via a direct interface or application or via a third party, will be referred to synonymously as “users”.

When this system is used to process a transaction, it will identify the transacting user and execute various authorization verifications. Each user can create an individual set of authorization verifications defined before or during a transaction that act as criteria to be evaluated to issue a comprehensive authorization. Henceforth, verification criteria the system evaluates when determining what authorization to issue are referred to as “authorization evaluations”.

Authorization evaluations are ever changing based on the user's needs of the system.

To complete the evaluation of this criteria, the system evaluates data gathered before or during a transaction, received from any source for which the system is equipped.

This system can receive, send, and request payment data from, but not limited to, any of the components of EMV infrastructure: POS devices, acquirers, credit card networks, and issuers. Whether the system is an independent layer within EMV infrastructure or incorporated into a system equipped third party, users would be issued payment cards, which facilitate the system receiving and sending payment data. For the system to work as described, the system might require partnerships with acquirers, issuers, or credit card networks to request or receive payment data. This partnership could entail an acquirer, credit card network, or issuer becoming a system equipped third party, fixed fees, some kind of revenue sharing agreement, or a different arrangement depending on the terms of implementation and use.

This system is also equipped to intake data from any source which is able to transmit data in a format legible to the system. To start the system might use data from a dedicated application or interface, wearable devices, database entries, physical or software inputs, such as buttons, switches, levers, etc. This list does not exhaustively detail all sources of data. The system is equipped to handle new sources of data.

Users can add new datasets or equip the system to access live sources of data if they deem it necessary to achieve their desired comprehensive authorization.

This document seeks protection for the system to leverage any source or data type that could be aggregated in the system's transaction authorization flow with the goal of delivering a more comprehensive authorization. Henceforth any data collected to be used as transaction evaluation criteria is referred to as “conditional transaction data”.

Conditional transaction data is the data used to assess the authorization evaluations. One example of conditional transaction data being used could be a user that creates an authorization evaluation contingent upon biometric data entry, the system could require the user to input biometric data during a transaction. This biometric data is the conditional transaction data. If the user successfully inputs the required biometric information, the system would proceed with assessing funds, issuing ARQC or response cryptograms as appropriate depending on the implementation. If the user does not input the required information, the system could issue an AAC or decline the transaction.

One particularly noteworthy authorization evaluation for which the system is equipped is to check one or multiple funding sources. This is discussed in more detail later in this document, but it is noteworthy because the system would not only check for sufficient funds but also facilitate the transfer of funds to the merchant. How the system's transfer of funds would depend on the implementation of the system, the type of payment card issued, and most importantly, the system's relative location within EMV infrastructure.

This layer is specifically designed to receive payment data while it is in transmission via EMV infrastructure, identify the transacting user and their authorization evaluations, conduct authorization evaluations on conditional transaction data, and issue a comprehensive authorization. In practice this means that the system would take in an ARQC or response cryptogram, an ARPC or an AAC, associate it with a user of the system, identify their authorization evaluations, assess the conditional transaction data against the terms of the authorization evaluation, and issue an ARQC or response cryptogram that contains the transactions authorization.

Users of the system via direct application or interface are able to register, create an account, and specify authorization evaluations. Users of the system via third party are also able to create accounts, however based on the needs of the third party, user registration and establishing authorization evaluations without the user's input might be preferred, and is within the scope of the system's capabilities.

Depending on the implementation of the system, authorization evaluations can be linked directly to the user's account or the authorization evaluations can be linked to a specific payment card which has been issued to the user.

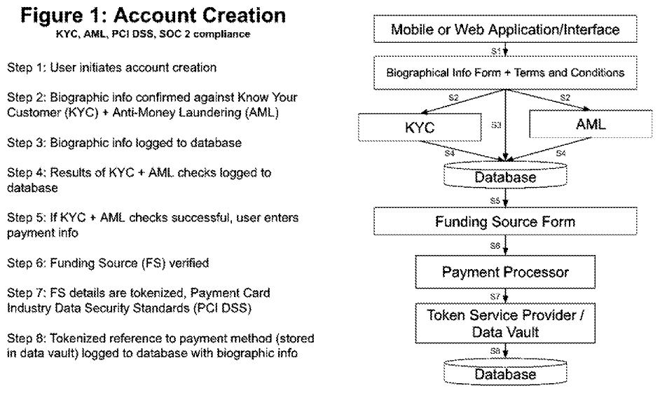

The account creation process within this system is user-friendly but also stringent, ensuring security and legitimacy for its users. FIG. 1 demonstrates the process of account creation. Once the account is established, users are prompted to review and agree to the system's terms and conditions about usage policies and data handling practices. Following the acceptance of the terms, users attach their preferred payment methods to their accounts.

This system supports a wide range of options for payment methods, including but not limited to debit cards, credit cards, bank accounts, digital wallets, gift cards, crypto wallets and other funding sources. The system is equipped with digital wallets, where users could store or upload funds to use for transactional purposes or simply as a store of funds. This system is designed to embrace and integrate emerging payment technologies, such as blockchain, and standards, such as crypto wallets, ensuring its longevity and relevance in the evolving financial landscape, and to encompass regular updates and maintenance to the system, ensuring it stays aligned with the latest security standards and technological advancements. Henceforth all of these payment methods, accounts, system issued wallets, etc. that can be used to fund a transaction via a payment card issued by the system or to fund a transaction for a system equipped third party are referred to simply as “funding sources”. Users can specify default funding sources and other account settings during this account creation.

After the user has created an account, this system is designed to cater to various scenarios based on the desired outcome. Users can declare their desired outcome by creating a collection of authorization evaluations that the system will evaluate during a transaction. Henceforth a collection, or group, of authorization evaluations input by a user is referred to as a “group”.

There are three types of authorization evaluations, “events”, “allocations”, and “criteria”, that users can enable for their group. When a user initiates a transaction with a system equipped payment card, via either a payment card issued directly by the system or indirectly by a system equipped third party, the system will receive an ARQC. Henceforth a payment card issued by the system or by a system equipped third party will be referred to as a “system equipped payment card”. The system will match the payment card to the group and conduct the authorization evaluation.

Events are actions that must occur for the system to issue an approval of the transaction. Events include but are not limited to the system requiring a PIN, biometric verification, two factor authentication from a secondary device, likely the user's mobile device or a POS device, within a specific time frame. As mentioned above, the system is equipped to receive data from any source, wearable electronic devices, binary input methods, etc. and thus, authorization events could be configured manually to user's preference. As users are able to create their own events and equip the system to handle any data source, the above list does not exhaustively detail all events for which the system is equipped to handle.

This system can also support the integration with artificial intelligence, AI, to create iterative or situational events. An example of an authorization event using AI would be to use AI to categorize purchases during a transaction. If a purchase falls outside the bounds of a user's budget, they have to override the AI otherwise the system would issue a rejection of the transaction. There are other applications of AI within this system beyond budgeting, such as helping user's adhere to goals, such as “I need to stop eating fast food. Decline any transactions for fast food.”, or time-boxing, such as “I cannot shop anywhere, online or in-person, between 9 am to 5 on because I am working!”. Implementing AI within the EMV authorization request system would provide users access to real time financial advice in accordance with their needs, goals, and desires.

Criteria are limitations on transaction conditions that system's authorization evaluations must assess to issue a transaction authorization. One innovative and noteworthy aspect of this system is that it can evaluate criteria that was included in an authorization request issued by the POS device. For example, the number of times that a payment card was used might be obtained from the transaction counter on the system equipped payment card and sent within the ARQC. Or the location of the transaction might be discernible from the data sent in a transaction authorization request. This functionality represents the system's ability to take data in transit via EMV infrastructure and perform evaluations that are beyond the scope of typical authorization requests.

This functionality would be employed when a user defines a group to use multiple funding sources. The system's purpose is to get approvals from each of the authorization evaluation checks in place, in this instance, an authorization evaluation would be a criteria to assess fund sufficiency in multiple funding sources. The system would receive an ARQC and details about the merchant or transaction via the system issued payment card. It would associate the PAN with a user and see that the authorization evaluation had a criteria to check for sufficient funds in multiple funding sources.

This represents another noteworthy and innovative aspect of the system. One method for the system to check on the amount of funds in a funding source is by sending a new authorization request, consisting of the ARQC, accompanying merchant data, and a fractional transaction amount based on user defined allocation criteria, the process for a user defining allocations to various funding sources is expanded upon later in this document.

Not only is the system able to take data in EMV infrastructure and conduct expanded authorizations, the system is also able to issue authorization requests to a funding source attached to a user's account and maintain the payment data in the initial authorization request, taken from EMV infrastructure, while simultaneously changing the amount of funds being requested by a particular funding source. This functionality is integral to the system's operation as it ensures compatibility with all funding sources that are already equipped to participate in EMV infrastructure.

Aside from issuing a new type of authorization request, the system can check on the amount of funds in a funding source by performing a real time balance check on the account. This functionality could be built as a feature of this system or integrated through the various partners of the issuer banks that receive information about their account holder's accounts, such as Plaid or MX. Alternatively, this system could support direct partnerships with issue banks.

This system could also evaluate criteria other than amount of funds with payment and non-payment data. As previously stated, the system can use data from any source. For example a user could stipulate before a transaction that their payment card can only facilitate transactions within a timeframe from group creation, be it from a number of seconds, minutes, hours, days, months, years, etc., Some other criteria could include number of uses of the system issued payment card, location of the transaction, amount of the transaction, permissible merchants or merchant categories, etc. As users are able to create their own criteria and equip the system to handle any data source, the above list does not exhaustively detail all criteria for which the system is equipped to handle.

Allocation refers to how users chose to allocate transactions to distinct funding sources. Users can specify exact percentages or dollar amounts apportioned to each participant or funding source within a group.

When the system is assessing authorization evaluations, it will aggregate all individual assessments of each criteria or event in a group to determine the appropriate next step.

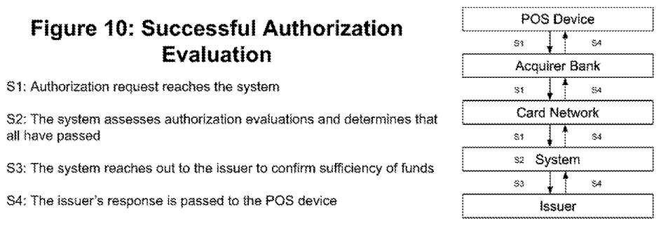

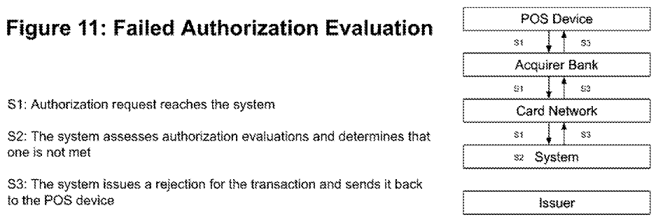

If the system is integrated into EMV infrastructure to receive data en route from POS to issuer, then the system receives an authorization request message. It would assess the authorization evaluations and aggregate all the results. If all of the authorization evaluations are passed successfully, then it would continue to send the ARQC, send an ARQC with the same merchant data but fractionalized transaction data, or do a real time balance check to the associated funding source, and pass on the appropriate response token after it receives the response from the issuer. This process is shown in FIG. 10. If one of the authorization evaluations fails, then the system can issue a rejection, or an AAC, without checking the sufficiency of funds. This process is shown in FIG. 11. This is just one example of how the system operates within EMV infrastructure and is able to use data in transit to provide users with the needed utility from a transaction. Henceforth the process of the system aggregating evaluations to respond to a transaction authorization request is referred to as “authorization aggregation”.

If all user's mobile devices have the system's mobile application, when users are physically together, they can create a group by tapping their mobile devices together leveraging the near field communications devices in user's mobile devices. Each user then reviews and accepts a digital invitation, proposes changes, or rejects the authorization evaluations. Initial settings are propagated from the most restrictive criteria declared in all participating users accounts.

When a user is creating a group with other users not in proximity or based on preference, the initiating user can send a digital invitation to other users. If the other users are registered with an account, they can accept the group settings, propose changes, or reject this digital invitation via the system's mobile or web application or interface. Users could have the same functionality via a third party's mobile or web application or interface but it is also possible that third parties handle digital invitations without user input. In the digital invitation, users can see the group settings, users in the group, if other users have accepted the invitation or not, and can change or add a funding source for their apportioned amount of the transaction. When users receive a digital invitation, the funding source is set to their account's default method or prompts the user to declare one in the case there is no default. Users have the ability to change this or the users in a group.

If an initiating user wants to create a group with a user that does not have an account with the system, the accountless user can receive and accept the invitation via a web interface where they input their funding source details given they agree to the group settings. This feature is especially useful when only one member of the group has the application.

Users are able to disable, delete, leave, or reactivate groups at any time.

The system accommodates various methods enabling users to leverage their newly formed group with the desire to initiate a transaction whether online or in-person, henceforth referred to as “presentation methods”. These presentation methods include but are not limited to virtual cards, physical cards, mobile applications, digital wallets, QR-based transactions, and even near field communications (NFC) enabled devices, like smartwatches and smartphones. Additionally, the system could integrate into existing payment cards or funding sources via a system equipped third party. These presentation methods, issued, created or controlled by the system, are critical to transmit data from the merchant's POS device to the system's central platform. The system could issue presentation methods to every user, upon account creation, or to every group, upon finalization of authorization evaluations or acceptance by other users.

If presentation methods are issued to every user and a user is only able to create one group, then the user's PAN is tied directly to their authorization evaluations. When a user transacts with their presentation method, a transaction cryptogram would reach the system, the system would decrypt the cryptogram and identify the PAN, determine the user's group's authorization evaluations, stored in the system's, system-equipped third parties', or third parties' central database, and being authorization aggregation.

Payment cards are typically issued to a specific account or wallet for a specific user. In the case of this system, payment cards can be linked to multiple funding sources or multiple users. To accommodate this, the system could employ an innovative system of tokenization to have one payment card reference a user, a group of users, or groups of authorization evaluations pertaining to one or multiple sources of funding. This patent seeks comprehensive protection for the tokenization of users and groups for transactional purposes for any model of processing method implementation, whether it is employed by this system or not. Upon forming a group, a unique token could be instantly generated and stored in the system's, system equipped third parties', or third parties' central database. This token, representing the group, would ensure linkage from the presentation method to the funding sources and authorization evaluations.

The system accommodates various methods for delivering a group token to the chosen presentation method, henceforth referred to as “token distribution methods”.

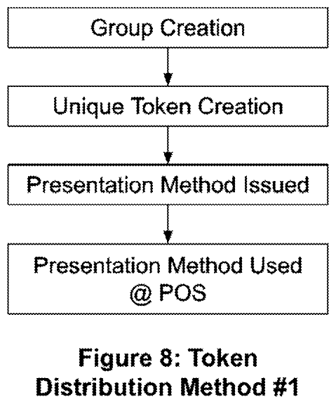

One token distribution method would be to issue a new presentation method for each unique token, or each group, as it is created. This would permanently link the presentation method's PAN, if the presentation method utilizes a PAN, to the group or the authorization evaluations. The sequence of events a user would encounter with this token distribution method is represented by FIG. 8.

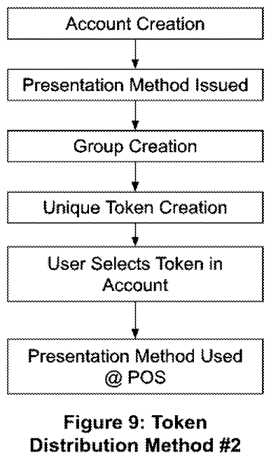

Another token distribution method allows for a presentation method, such as a virtual or physical card, to be issued during account creation. This presentation method's PAN is associated with the group the user has selected in the system's interface, henceforth referred to as the user's “active group”. This means without altering the user's system issued presentation method's PAN or Bank Identification Number (BIN) but by changing the user's active group, the same presentation method PAN could access funds from two different locations for two different transactions or more generally, have two different authorization evaluations for two different transactions. In practice this works via the application or interface, the user selects which group, or token, the presentation method should utilize when it is presented at a POS device. Each token represents a distinct group. The sequence of events a user would encounter with this token distribution method is represented by FIG. 9. When the system identifies the presentation method's PAN, it can associate it with a user account. From there, it is quickly able to ascertain the group and its authorization evaluations.

While the system is designed to enable a presentation method to access and represent multiple funding sources via one token, it also includes the capability for a presentation method to be configured to exclusively access and represent a single funding source. This feature allows a presentation method to effectively operate as a direct link to one specific funding source, based on user preference.

These token distribution methods ensure that the system can accommodate various preferences, scenarios, integrations, and enables users to participate in multiple groups simultaneously, making it a comprehensive solution for modern payment challenges. Token distribution methods are a means to achieve the end goal. This patent seeks comprehensive protection for the transacting with multiple funding sources via any means of implementation.

Modern payment devices are inherently versatile. Though traditionally designed for card data and cryptogram transmission, they can also handle tokenized data, like that used in mobile payment systems, such as Apple Pay® or Google Pay®. Given EMV infrastructure is already equipped to handle tokenized transaction data, bundled as cryptograms, whether in-person or online, the process for transactions using a token issued by this system could be implemented so as to not change, alter, or affect any of the existing EMV infrastructure for parties involved, card networks, acquiring banks, and issuing banks. Henceforth any and all data transmitted with a group token, adjunctly or individually from a POS devices, via any iteration of this system's presentation method, will be referred to as “system-equipped cryptograms”, given these cryptograms include tokens generated by this system as well as the accompanying transaction data.

The system-equipped cryptogram is transmitted from the POS device to the central platform, or a system integrated with the central platform. After the central platform receives the system-equipped cryptogram, it would decrypt the cryptogram to identify a PAN it can associate with a user or group directly, and assess authorization evaluations. There are various methods to transmit the data from POS device to the central platform briefly touched upon earlier, that are henceforth referred to as “processing methods”.

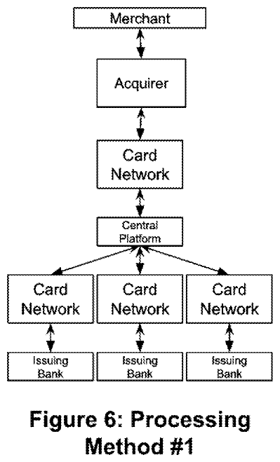

One processing method mentioned briefly earlier in this document, is to position the system's central platform directly following the card network in a figurative flow of events. Card networks' typical function is to receive communication from merchant's acquirer, identify the user's bank, and pass the authorization request and response along to the appropriate parties. In such a system, the card network (like Visa®) would recognize the presentation method as issued by the system, system equipped third party, or third party and transmit cryptograms, system-equipped or not, to the central platform, likely via transmission control protocol (TCP) or hypertext transfer protocol (HTTP) connection, to then be decrypted and evaluated. This process is shown at a high level in FIG. 6. The system could support and integrate with multiple card networks simultaneously.

Another processing method leverages communication with merchant's acquirers, instead of card networks. Acquirers are responsible for receiving transaction details (cryptograms) from the merchant's POS devices, obtaining authorization from the card network (like Visa®, Mastercard®), and then facilitating the transfer of funds from the issuing bank (the cardholder's bank) to the merchant.

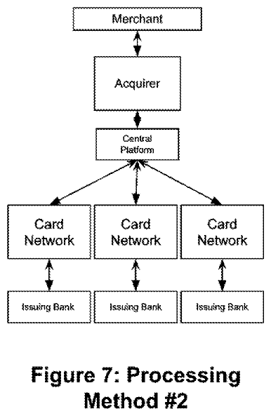

If this system was integrated with acquirers, when the acquirer identifies the user's presentation method as issued by the system, system equipped third party, or third party, it would initiate communication with the central platform/split fee payment system server to begin evaluation of authorization evaluations. Additionally, acquirers might alleviate some of the actions performed by the central platform as acquirers are typically equipped with payment processing capabilities and would be able to check for sufficient funds across all funding sources. This processing method might necessitate a new presentation method, independent of major card network BIN numbers, to facilitate the acquirer identifying that the presentation method was issued by the central platform. If this processing method, with a new presentation method, was to be implemented at a universal scale, where any user could go to any merchant, it would likely necessitate the system's integration with every acquirer or payment processor, making setup tedious. This infrastructure is shown in FIG. 7.

Lastly, within EMV infrastructure, this system could integrate with the issuing banks. This might not be the broadest application but it could be the simplest. The issuing bank is already set to receive and decrypt a transaction cryptogram. When it does, the bank could initiate communication with the central platform to perform an evaluation of the group's settings. This issuing bank could be the issuer of the system's presentation methods or the issuer of the user's funding sources.

Advanced authorization integrated with an issuer bank is typically referred to as “multi-level authorization.” Typically multi-level authorization assess additional data sent in the original authorization request transmission. It is called multi-level because authorization occurs at several stages or levels. Multi-level authorization systems are limited by their issuer bank partner in their ability to add new authorization layers, communicate with and aggregate funds from additional funding sources, and add additional datasets or sources to their authorization calculation, unlike this system which is equipped to handle these described scenarios, allowing more comprehensive and situationally adaptable authorizations.

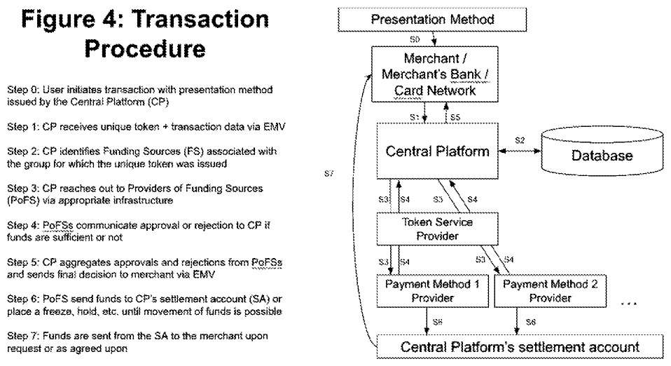

When this system approves a transaction, if a group uses multiple funding sources the system would facilitate an automated process to transfer funds into a designated settlement account, earmarked for reimbursing the merchant until the merchant “collects” funds at the POS device. This described settlement process is integral to facilitating transactions and could be implemented in a variety of ways based on the system's location relative to EMV infrastructure. In scenarios where transferring funds from their original source is not feasible or the most efficient solution, the system implements a safeguard by freezing or placing a hold on the funds in the current account. This hold remains in place until the system can successfully move the funds to the settlement account or to the merchant of record. In the event that neither transferring funds nor placing them on hold is possible, the system has a contingency plan including but not limited to incurring overdraft fees, refraining from issuing an approval, or using an alternative funding source associated with the user's account. The user will agree to edge case handling, such as insufficient funds, prior to transacting. This process is shown in detail in FIG. 4.

This system seeks protection for the underlying technology for any implementation of a system that provides more comprehensive authorizations via novel tokenization or not to provide users or groups of users expanded capabilities or more security when transacting. The innovative nature of this system lies in its ability to evaluate various data points and aggregate the evaluations to issue one comprehensive approval or rejection to the merchant using existing EMV infrastructure. Some examples of this system in practice could be to allow:
a. An individual user to confirm a transaction from a secondary device before their issuer is contacted or any funding is processed.
b. An individual user could pay with multiple funding sources for one transaction.
c. An individual user to spend a certain amount of money but no more. This could help with budgeting.
d. An individual user to spend with the live guidance of AI providing financial advice.
e. An individual user to leverage the system's capabilities for managing recurring payments.
f. An individual user to enable the system to charge whichever funding source is best for accumulation of rewards. The system can discern the merchant's category code and determine which funding source has the best rewards pertaining to that category.
g. A group of users to pay with multiple funding sources for one transaction.
h. A group of users to each confirm a transaction from a secondary device before their issuers are contacted or any funding is processed.
i. A group of users to spend a certain amount of money but no more. This could help with budgeting.
j. A group of users to spend with the live guidance of AI providing financial advice.
k. A group of users to leverage the system's capabilities for managing recurring payments.
l. A business to pull funds from multiple bank accounts.
m. A business or organization to have greater control and expense management. They could create a group with the accountant or treasurer as the owner and the agent of the entity who is transacting, giving them access to the entity's payment card or funding source, while adding spend or geographical limits, allocations, etc. to control the entity's agent's spending in real time. The accountant or treasurer could deactivate the group at any time.
n. A business to integrate rewards processes directly into payments.
o. A business to leverage the system's capabilities for managing recurring payments for their consumers or for themself.
p. A business could automate payments for contract milestones.
q. A doctor's office to determine if a patient's insurance is within their coverage network and facilitate payment from the insurance company and their patient's funding sources.

This list is not exhaustive and this document seeks protection for any application of this innovative system. This system's comprehensive authorizations provide many combinations of events, criteria, and allocations that in conjunction present a gamut of utilities from simplifying individual's transactions, enabling group-based payments or individuals with multiple cards, enhancing data transmission capabilities, and providing a unified record of all transactions.

A unified record of transactions could be displayed to users via the system's or third parties' mobile or web applications or interfaces.

Once a multi-funding source group is created, whether using the tokenization method proposed or an alternative, any expenses incurred can be charged to the collective, bypassing the conventional hassles and costs of individual transfers or money requests. While the invention might detail a specific tokenization process, the document intends to secure rights over the broader concept of facilitating payments from one payment card that can reference multiple users in conjunction, while the users and one or multiple funding sources associated with the payment card differing from use to use, without necessitating individual transfers between transaction participants, time waiting for repayment or sending repayment requests, tracking expenditure per person, or saving receipts to input into an expense management system.

Adequate measures are taken to guard user identities and transaction data in order to uphold the system's trustworthiness. This system is designed with a strong emphasis on data privacy and security, adhering to the highest industry standards. Compliance with the PCI DSS ensures that all cardholder data handled by the system is protected against breaches and misuse. Additionally, this system adheres to Service Organization Control 2 (SOC 2) standards, which govern how it manages and secures user data. These rigorous controls over data processing, storage, and transmission, ensure user privacy is maintained at all times. The system's architecture and operational procedures are structured to safeguard sensitive payment information, following stringent security measures.

This system's utility extends to the realm of subscription services and bill payments. Users can leverage the system's tokenization capabilities to manage and facilitate payments for various subscriptions and bills, such as streaming services, utility payments, or membership fees. By associating their funding sources with the system, users can set up automatic payments for their recurring expenses. Additionally, users can enable the system to automatically distribute charges across multiple funding sources or seek approval via events.

The system's tokenization method presents a novel payment application enabling group chats to make payments with multiple funding sources. Users can share various booking options, such as restaurants, flights, concert tickets, accommodations, and more. Upon consensus, the group can jointly pay for the chosen service or product directly from the app or from a group chat infrastructure that has integrated this system. This feature not only streamlines the payment process but eradicates the need for payment splits or reimbursements during the actual event or experience. By encompassing this feature, the document seeks to claim rights over any method that facilitates group payments through a chat interface, whether it employs this system's tokenization mechanism or another system entirely. If this system was to be integrated into a group chat facilitator, then the token would be issued to the group chats. If this system offered group chat functionality, then users could make reservations, bookings, purchases from within the system while the system would handle the payment allocations to each user appropriately.

Further expanding on the system's capabilities, this invention also proposes a method of facilitating payments through text messaging. In this scenario, users or groups can simply text a tokenized reference, generated by the merchant or during group creation, to a central platform. This unique identifier serves as the means to execute the transaction. The central platform would leverage the user's group settings to authorize and facilitate the payment. In embracing this innovative functionality, the patent aims to secure rights over any methodology that facilitates payments through textual identifiers.

The system is designed to cater to a diverse range of users, from individual consumers to large-scale organizations. The architecture of the system is built to handle an increasing volume of transactions and users efficiently, employs load balancing and distributed processing techniques to ensure that the system can manage high transaction volumes, even during peak usage times, maintaining high speed and reliability. Data storage and processing capabilities are designed to expand in response to an increased number of users or a surge in transaction activity. This ensures that the system remains responsive and efficient, regardless of user load. This ensures the system is not only capable of meeting current demands but is prepared to adapt to future expansions in the user base, transaction volume, and compliance standards.

The following real-life examples demonstrate the practical application of this system in managing multi-funding source transactions.

The first scenario illustrates how an individual user with multiple funding sources, such as a credit card and a debit card, can seamlessly integrate and use these methods for transactions. This example highlights the system's capacity to handle multiple payment sources for a single user.

Single User with Multiple Funding Sources: In this scenario, a user already registered on the platform decides to combine their credit and debit cards for a purchase in-store. The user enters the system's application and forms a group consisting of their credit and debit card and does not specify any other authorization evaluations. When this group is selected in the app or the group's corresponding presentation method is used, the central platform receives the PAN and transaction data. It then identifies the group associated with the token, verifies there are sufficient funds in the user's two chosen funding sources, debit card and credit card in this case, either via authorization request to the issuer of the funding sources or via real time available balance check of those funding sources. If there are sufficient funds, the system then authorizes the transaction and orchestrates a fund transfer from the user's accounts to the merchant.

The second scenario showcases the system's capability to facilitate a shared transaction between a user and their friend, combining their individual funding sources into a single transaction.

Multiple Users Sharing Payment: In another real-world application, a user aims to share a purchase cost using their credit card and a friend's debit card. The user initiates a group in the app comprising these two users. The user's friend receives a digital invitation to join this group, selects their debit card, and accepts the invitation. Upon acceptance, the system issues a virtual card accessible via the group in the mobile app. When a transaction is initiated using this group's presentation method, the virtual card, the system processes the token and transaction data to ascertain the group's identity. It then checks for sufficient funds in both the user's and the friend's linked funding sources. If the funds are adequate, the system approves the transaction and manages the subsequent transfer of funds to the merchant.

This third scenario showcases the system's capability to confirm authorization events using the presentation method's PAN during the time of a transaction.

Two factor authentication transaction: In this example, a user has configured their group to trigger a popup in their mobile application when a transaction occurs. This popup aims to collect approval from the initiating user as a step in issuing approval for the transaction. When the user initiates a transaction, the system's central platform identifies that the presentation method is associated with the popup event check authorization evaluation. The user enters their mobile app and approves the transaction in the popup window. The system reaches out to the funding source for approval and passes approval back to the merchant if the funds are adequate.

The final scenario showcases an example where the group was created for a specific type of transaction that did not need to confirm the presence of funds, but some other conditions were in place, in order to issue approval for the transaction.

Non-funded transaction: A user is at a particular third party merchant, who has integrated the system to manage its reward program. The user has a free purchase on their account. When the user uses their presentation method, the system receives the PAN and associates it with the correct group. It recognizes that the user has amassed enough rewards points for a free purchase and issues approval without needing to identify if the funds exist or not.

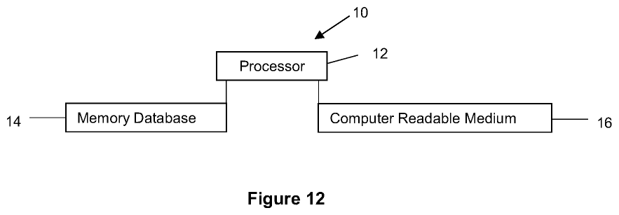

Consistent with the above description, as shown in FIG. 12, a system user computer 10 includes (a) at least one processor 12, (b) at least one memory database 14, connected to the processor, and (c) a computer readable medium 16 coupled to the processor. The computer readable medium 16 comprises code that is executable by the processor 12 to cause the processor to implement a method that includes the steps of: (1) creating an account for split fee payments for a financial transaction from multiple funding sources using payment processing infrastructure of a merchant and (2) specifying authorization evaluations required to approve the financial transaction. The system user computer may be a communication device having internet access. This includes, but is not limited to, mobile devices such as cell phones.

As set forth above, the authorization evaluations are selected from a group consisting of an event, an allocation, a criteria or combinations thereof. An event may be a personal identification number (PIN), a biometric verification, multi-factor authentication, two factor authorization from a secondary communication device within a specified time frame, an approval generated by artificial intelligence, another action to confirm the financial transaction is legitimate or combinations thereof. An allocation may be a percentage or dollar amount of the financial transaction to be apportioned to (a) each participant of the account, (b) each of the multiple funding sources or (c) each participant of the account and each of the multiple funding sources. A criteria may be a limitation on transaction conditions. Limitations may include, but are not necessarily limited to a maximum transaction amount, a maximum number of transactions, a merchant exclusion, a type of good or service purchase exclusion, a geographic merchant exclusion (e.g. no purchase allowed from merchant's located outside of the state of New York) or the like.

The method may further include adding at least one of the following to the account: (a) a new participant, (b) a new funding source and (c) a new authorization evaluation. The method may further include linking authorization evaluations to (a) a participant account, (b) a particular funding source or (c) a participant account and a particular funding source. Still further, the method may include transmitting account information to a server computer for a split fee payment system.

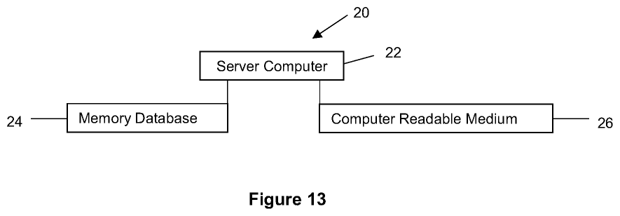

As illustrated in FIG. 13, a split fee payment system 20 includes (a) at least one server computer 22, (b) at least one memory database 24, connected to the server computer, and (c) a computer readable medium 26 coupled to the server computer. The computer readable medium 26 comprises code executable by the server computer 22, to cause the server computer to implement a method comprising:

receiving account information from a system user computer including participant data, multiple funding source data and authorization evaluation data;

storing the account information, including the participant data, the multiple funding source data and the authorization evaluation data, in the memory database;

receiving (i) information for a financial transaction from financial institution infrastructure including a point of sale device, a merchant bank, a credit card network and a credit card issuer and (ii) any transmitted authorization evaluation data from the system user computer of the participant;

analyzing the information and the transmitted authorization evaluation data against the account information to determine (a) participants involved in the financial transaction, (b) if sufficient funds are available at the funding sources of the participants involved in the financial transaction and (c) if the transmitted authorization evaluation data matches the stored authorization evaluation data to approve the financial transaction; and

sending an approval or rejection of the financial transaction to the point of sale device.

The method may further include receiving funds from the funding sources for the financial transaction in a split fee payment system settlement account and sending the funds from the split fee payment system settlement account to the merchant's bank. The method may also include sending to, receiving from and requesting payment data from any component of a financial institution infrastructure including point of sale devices, merchant banks, credit card networks and credit card issuers.

As fully supported by the foregoing, a method of facilitating split fee payments, includes steps of:

receiving account information from a system user computer including participant data, multiple funding source data and authorization evaluation data;

storing the account information, including the participant data, the multiple funding source data and the authorization evaluation data, in the memory database;

receiving (i) information for a financial transaction from a financial institution infrastructure including a point of sale device, a merchant bank, a credit card network and a credit card issuer and (ii) any transmitted authorization evaluation data from the system user computer of the participant;

analyzing the information and the transmitted authorization evaluation data against the account information to determine (a) participants involved in the financial transaction, (b) if sufficient funds are available at the funding sources of the participants involved in the financial transaction and (c) if the transmitted authorization evaluation data matches the stored authorization evaluation data to approve the financial transaction; and

sending an approval or rejection of the financial transaction to the point of sale device.

Still further, the method may include one or more of the following additional steps:

receiving funds from the funding sources for the financial transaction in a split fee payment system settlement account and sending the funds from the split fee payment system settlement account to the merchant's bank;

selecting authorization evaluation data from a group consisting of an event, an allocation, a criteria or combinations thereof; and

sending to, receiving from and requesting payment data from any component of a financial institution infrastructure including point of sale devices, merchant banks, credit card networks and credit card issuers.

Alternatively, the method of facilitating split fee payments may be considered to include the steps of:

integrating into a financial institution infrastructure, including a point of sale device, a merchant bank, a credit card network and a credit card issuer, a server computer and a memory database including a computer readable medium coupled to the server computer, the computer readable medium comprising code executable by the server computer, to cause the server computer to be adapted for:

receiving, interpreting, utilizing, manipulating and sending, by the server computer, data via financial institution infrastructure request and response cryptograms;

receiving, by the server computer, authorization evaluation data from mobile communication devices of users outside of the financial institution infrastructure;

analyzing, by the server computer, financial transaction information received from the financial institution infrastructure and transmitted authorization evaluation data received from mobile communication devices of users to determine (a) participants involved in a financial transaction, (b) if sufficient funds are available at funding sources of participants involved in the financial transaction and (c) if the transmitted authorization evaluation data matches stored authorization evaluation data to approve the financial transaction; and

sending, by the server computer, an approval or rejection of the financial transaction to the point of sale device.

For purposes of this document, “integrating into a financial institution infrastructure” includes incorporating into a component of that infrastructure or inserting between existing components of that infrastructure.

Still further, that method may include one or more of the following additional steps:

issuing, by the server computer, tokens representing a user, a group of users, a funding source, a group of funding sources, an authorization evaluation, a group of authorization evaluations and combinations thereof;

receiving, by the server computer, funds from any funding sources for the financial transaction in a split fee payment system settlement account and sending, by the server computer, the funds from the split fee payment system settlement account to the merchant's bank;

issuing, by the server computer, a payment method; and

linking, by the server computer, the payment method to (a) a user account, (b) a token or (c) a user account and a token.

This disclosure may be said to relate to the following items.
1. A system user computer, comprising:
   a processor;
   a memory database connected to the processor; and
   a computer readable medium coupled to the processor, the computer readable medium comprising code executable by the processor, to cause the processor to implement a method comprising:
   creating an account for split fee payments for a financial transaction from multiple funding sources using payment processing infrastructure of a merchant; and
   specifying authorization evaluations required to approve the financial transaction.
2. The system user computer of item 1, wherein the authorization evaluations are selected from a group consisting of an event, an allocation, a criteria or combinations thereof.
3. The system user computer of item 2, wherein the event is a personal identification number (PIN), a biometric verification, multi-factor authentication, two factor authorization from a secondary communication device within a specified time frame, an approval generated by artificial intelligence, another action to confirm the financial transaction is legitimate or combinations thereof.
4. The system user computer of item 3, wherein the allocation is a percentage or dollar amount of the financial transaction to be apportioned to (a) each participant of the account, (b) each of the multiple funding sources or (c) each participant of the account and each of the multiple funding sources.
5. The system user computer of item 4, wherein the criteria is a limitation on transaction conditions.
6. The system user computer of item 2, wherein the allocation is a percentage or dollar amount of the financial transaction to be apportioned to (a) each participant of the account, (b) each of the multiple funding sources or (c) each participant of the account and each of the multiple funding sources.
7. The system user computer of item 2, wherein the criteria is a limitation on transaction conditions.
8. The system user computer of item 1, wherein the method further comprises adding at least one of the following to the account: (a) a new participant, (b) a new funding source and (c) a new authorization evaluation.
9. The system user computer of item 8, wherein the method further includes linking authorization evaluations to (a) a participant account, (b) a particular funding source or (c) a participant account and a particular funding source.
10. The system user computer of item 1, wherein the method further includes transmitting account information to a server computer for a split fee payment system.
11. The system user computer of item 1, wherein the computer is a communication device having internet access.
12. A split fee payment system, comprising:
   a server computer;
   a memory database connected to the server computer;
   a computer readable medium coupled to the server computer, the computer readable medium comprising code executable by the server computer, to cause the server computer to implement a method comprising:
   receiving account information from a system user computer including participant data, multiple funding source data and authorization evaluation data;
   storing the account information, including the participant data, the multiple funding source data and the authorization evaluation data, in the memory database;
   receiving (i) information for a financial transaction from financial institution infrastructure including a point of sale device, a merchant bank, a credit card network and a credit card issuer and (ii) any transmitted authorization evaluation data from the system user computer of the participant;
   analyzing the information and the transmitted authorization evaluation data against the account information to determine (a) participants involved in the financial transaction, (b) if sufficient funds are available at the funding sources of the participants involved in the financial transaction and (c) if the transmitted authorization evaluation data matches the stored authorization evaluation data to approve the financial transaction; and
   sending an approval or rejection of the financial transaction to the point of sale device.
13. The split fee payment system of item 12, wherein the method further includes receiving funds from the funding sources for the financial transaction in a split fee payment system settlement account and sending the funds from the split fee payment system settlement account to the merchant's bank.
14. The split fee payment system of item 13, wherein the authorization evaluation data are selected from a group consisting of an event, an allocation, a criteria or combinations thereof.
15. The split fee payment system of item 14, wherein the event is a personal identification number (PIN), a biometric verification, multi-factor authentication, two factor authorization from a secondary communication device within a specified time frame, another action to confirm the financial transaction is legitimate or combinations thereof.
16. The split fee payment system of item 15, wherein the allocation is a percentage or dollar amount of the financial transaction to be apportioned to (a) each participant of the account, (b) each of the multiple funding sources or (c) each participant of the account and each of the multiple funding sources.
17. The split fee payment system of item 16, wherein the criteria is a limitation on transaction conditions.
18. The split fee payment system of item 14, wherein the allocation is a percentage or dollar amount of the financial transaction to be apportioned to (a) each participant of the account, (b) each of the multiple funding sources or (c) each participant of the account and each of the multiple funding sources.
19. The split fee payment system of item 14, wherein the criteria is a limitation on transaction conditions.
20. The split fee payment system of item 12, wherein the method further includes sending to, receiving from and requesting payment data from any component of a financial institution infrastructure including point of sale devices, merchant banks, credit card networks and credit card issuers.
21. The split fee payment system of item 20, wherein the system user computer comprises a communication device having internet access.
22. A method of facilitating split fee payments, comprising receiving account information from a system user computer including participant data, multiple funding source data and authorization evaluation data;
   storing the account information, including the participant data, the multiple funding source data and the authorization evaluation data, in the memory database;
   receiving (i) information for a financial transaction from a financial institution infrastructure including a point of sale device, a merchant bank, a credit card network and a credit card issuer and (ii) any transmitted authorization evaluation data from the system user computer of the participant;
   analyzing the information and the transmitted authorization evaluation data against the account information to determine (a) participants involved in the financial transaction, (b) if sufficient funds are available at the funding sources of the participants involved in the financial transaction and (c) if the transmitted authorization evaluation data matches the stored authorization evaluation data to approve the financial transaction; and
   sending an approval or rejection of the financial transaction to the point of sale device.
23. The method of item 22, further including receiving funds from the funding sources for the financial transaction in a split fee payment system settlement account and sending the funds from the split fee payment system settlement account to the merchant's bank.
24. The method of item 22, further including selecting authorization evaluation data from a group consisting of an event, an allocation, a criteria or combinations thereof.
25. The method of item 24, wherein the event is a personal identification number (PIN), a biometric verification, multi-factor authentication, two factor authorization from a secondary communication device within a specified time frame, an approval generated by artificial intelligence, another action to confirm the financial transaction is legitimate or combinations thereof.
26. The method of item 25, wherein the allocation is selected from a group consisting of a percentage or dollar amount of the financial transaction to be apportioned to (a) each participant of the account, (b) each of the multiple funding sources or (c) each participant of the account and each of the multiple funding sources.
27. The method of item 26, wherein the criteria is a limitation on transaction conditions.
28. The method of item 22, further including sending to, receiving from and requesting payment data from any component of a financial institution infrastructure including point of sale devices, merchant banks, credit card networks and credit card issuers.
29. A method of facilitating split fee payments, comprising:
   integrating into a financial institution infrastructure including a point of sale device, a merchant bank, a credit card network and a credit card issuer, a server computer and a memory database including a computer readable medium coupled to the server computer, the computer readable medium comprising code executable by the server computer, to cause the server computer to be adapted for:
   receiving, interpreting, utilizing, manipulating and sending, by the server computer, data via financial institution infrastructure request and response cryptograms;
   receiving, by the server computer, authorization evaluation data from mobile communication devices of users outside of the financial institution infrastructure;
   analyzing, by the server computer, financial transaction information received from the financial institution infrastructure and transmitted authorization evaluation data received from mobile communication devices of users to determine (a) participants involved in a financial transaction, (b) if sufficient funds are available at funding sources of participants involved in the financial transaction and (c) if the transmitted authorization evaluation data matches stored authorization evaluation data to approve the financial transaction; and
   sending, by the server computer, an approval or rejection of the financial transaction to the point of sale device.
30. The method of item 29, including issuing, by the server computer, tokens representing a user, a group of users, a funding source, a group of funding sources, an authorization evaluation, a group of authorization evaluations and combinations thereof.
31. The method of item 29, including receiving, by the server computer, funds from any funding sources for the financial transaction in a split fee payment system settlement account and sending, by the server computer, the funds from the split fee payment system settlement account to the merchant's bank.
32. The method of item 29, including issuing, by the server computer, a payment method.
33. The method of item 32, including linking, by the server computer, the payment method to (a) a user account, (b) a token or (c) a user account and a token.

The system user computer, split fee payment system and related methods of facilitating split fee payments described in this document provide a number of unique benefits and advantages.
The system issues comprehensive authorizations that consider not only the amount of funds required to transact and fraud criteria, but also conditions defined by the user, system, or a third party before issuing a transaction authorization to the merchant.
   The calculation of the authorization messages changes, but the content of authorization messages does not change.
The system can receive, interpret, utilize, manipulate, and send data in transmission via financial institution infrastructure, request and response cryptograms.
   It can be an independent layer within the infrastructure which is novel or unique or it can be integrated into any existing party within the infrastructure.
The system is also able to intake data or inputs from non-infrastructure sources to evaluate other conditions. The following list does not exhaustively detail all of the potential data or inputs that could be involved in this system but some examples are:
   A visual interface provided by the system or a third party
   A third party's APIs
   Users' or third parties' datasets
   An AI that has been trained on the user's goals
   Balance of additional funding sources
   External authorization, similar to multi-factor authentication (MFA)
   Example use cases
      MFA in a transaction, requiring biometric verification before authorizing a transaction.
      Deactivate a card after a certain number of days.
      Users can charge multiple bank accounts in one transaction.
The system issues tokens. A token can represent a user, a group of users, a funding source, a group of funding sources, an authorization evaluation, a group of authorization evaluations, or any combination of these options. Here are some examples of when the system would issue a token.
   A group of funding sources are linked together. These funding sources can be owned by distinct individuals or the same person.
   A set of authorization evaluations are created. As explained in greater detail above, authorization evaluations are either events, allocations, or criteria.
   A set of authorization evaluations are created with a group of funding sources.
   Users can create tokens with their friends by accepting a digital invitation or by tapping mobile devices together.
The system issues payment methods.
   Payment methods can be issued uniquely for each
      Token that is created
      User and then associated with the desired token before transacting
   This payment method's identifier, usually a PAN, can be associated with a token issued by the system. Traditionally a PAN is associated with a bank account.
   The system receives the transacting card's PAN during a transaction and is able to deduce which token is being used. (So it knows which authorization evaluations to consider, and which funding sources are involved.)
   The system provides for tokenization of users and groups for transactional purposes for any model of processing method implementation, whether it is employed by this system or not.
   The system offers
      A bill payment solution leveraging tokenization
      A method for collecting payment from group chats for one transaction
      A marketplace whereby users can charge multiple funding sources for one transaction
This system created a unified transaction record that displays total cost, and how that affected authorization evaluations or distinct funding sources

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a point of sale device”, as used herein, may also refer to, and encompass, a plurality of point of sale devices.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the system user computer, split fee payment system and method of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

1. A system user computer, comprising:
a processor;
a memory database connected to the processor; and
a computer readable medium coupled to the processor, the computer readable medium comprising code executable by the processor, to cause the processor to implement a method comprising:
creating an account for split fee payments for a financial transaction from multiple funding sources using payment processing infrastructure of a merchant; and
specifying authorization evaluations required to approve the financial transaction.

2. The system user computer of claim 1, wherein the authorization evaluations are selected from a group consisting of an event, an allocation, a criteria or combinations thereof.

3. The system user computer of claim 2, wherein the event is a personal identification number (PIN), a biometric verification, multi-factor authentication, two factor authorization from a secondary communication device within a specified time frame, an approval generated by artificial intelligence, another action to confirm the financial transaction is legitimate or combinations thereof.

4. The system user computer of claim 3, wherein the allocation is a percentage or dollar amount of the financial transaction to be apportioned to (a) each participant of the account, (b) each of the multiple funding sources or (c) each participant of the account and each of the multiple funding sources.

5. The system user computer of claim 4, wherein the criteria is a limitation on transaction conditions.

6. The system user computer of claim 2, wherein the allocation is a percentage or dollar amount of the financial transaction to be apportioned to (a) each participant of the account, (b) each of the multiple funding sources or (c) each participant of the account and each of the multiple funding sources.

7. The system user computer of claim 2, wherein the criteria is a limitation on transaction conditions.

8. The system user computer of claim 1, wherein the method further comprises adding at least one of the following to the account: (a) a new participant, (b) a new funding source and (c) a new authorization evaluation.

9. The system user computer of claim 8, wherein the method further includes linking authorization evaluations to (a) a participant account, (b) a particular funding source or (c) a participant account and a particular funding source.

10. The system user computer of claim 1, wherein the method further includes transmitting account information to a server computer for a split fee payment system.

11. The system user computer of claim 1, wherein the computer is a communication device having internet access.

12. A split fee payment system, comprising:
a server computer;
a memory database connected to the server computer;
a computer readable medium coupled to the server computer, the computer readable medium comprising code executable by the server computer, to cause the server computer to implement a method comprising:
receiving account information from a system user computer including participant data, multiple funding source data and authorization evaluation data;
storing the account information, including the participant data, the multiple funding source data and the authorization evaluation data, in the memory database;
receiving (i) information for a financial transaction from financial institution infrastructure including a point of sale device, a merchant bank, a credit card network and a credit card issuer and (ii) any transmitted authorization evaluation data from the system user computer of the participant;
analyzing the information and the transmitted authorization evaluation data against the account information to determine (a) participants involved in the financial transaction, (b) if sufficient funds are available at the funding sources of the participants involved in the financial transaction and (c) if the transmitted authorization evaluation data matches the stored authorization evaluation data to approve the financial transaction; and
sending an approval or rejection of the financial transaction to the point of sale device.

13. The split fee payment system of claim 12, wherein the method further includes receiving funds from the funding sources for the financial transaction in a split fee payment system settlement account and sending the funds from the split fee payment system settlement account to the merchant's bank.

14. The split fee payment system of claim 13, wherein the authorization evaluation data are selected from a group consisting of an event, an allocation, a criteria or combinations thereof.

15. The split fee payment system of claim 14, wherein the event is a personal identification number (PIN), a biometric verification, multi-factor authentication, two factor authorization from a secondary communication device within a specified time frame, another action to confirm the financial transaction is legitimate or combinations thereof.

16. The split fee payment system of claim 15, wherein the allocation is a percentage or dollar amount of the financial transaction to be apportioned to (a) each participant of the account, (b) each of the multiple funding sources or (c) each participant of the account and each of the multiple funding sources.

17. The split fee payment system of claim 16, wherein the criteria is a limitation on transaction conditions.

18. (canceled)

19. (canceled)

20. The split fee payment system of claim 12, wherein the method further includes sending to, receiving from and requesting payment data from any component of a financial institution infrastructure including point of sale devices, merchant banks, credit card networks and credit card issuers.

21. The split fee payment system of claim 20, wherein the system user computer comprises a communication device having internet access.

22. A method of facilitating split fee payments, comprising
receiving account information from a system user computer including participant data, multiple funding source data and authorization evaluation data;
storing the account information, including the participant data, the multiple funding source data and the authorization evaluation data, in the memory database;
receiving (i) information for a financial transaction from a financial institution infrastructure including a point of sale device, a merchant bank, a credit card network and a credit card issuer and (ii) any transmitted authorization evaluation data from the system user computer of the participant;
analyzing the information and the transmitted authorization evaluation data against the account information to determine (a) participants involved in the financial transaction, (b) if sufficient funds are available at the funding sources of the participants involved in the financial transaction and (c) if the transmitted authorization evaluation data matches the stored authorization evaluation data to approve the financial transaction; and
sending an approval or rejection of the financial transaction to the point of sale device.

23-33. (canceled)
